(19) United States
(12) Patent Application Publication
(10) Pub. No.: US 2026/0167895 A1
(43) Pub. Date: Jun. 18, 2026

(54) LAUNDRY DETERGENT ARTICLE

(71) Applicant: Church & Dwight Co., Inc., Princeton, NJ (US)

(72) Inventors: Rohin NAIR, Monmouth Junction, NJ (US); Sae Y. KIM, Palisades Park, NJ (US); Steven ADAMY, Charleston, WV (US); Serena Sandra GIL, Somerset, NJ (US); Tyler P. WOODEN, Burlington, NJ (US)

(73) Assignee: Church & Dwight Co., Inc., Princeton, NJ (US)

(21) Appl. No.: 19/420,855

(22) Filed: Dec. 16, 2025

Related U.S. Application Data
(60) Provisional application No. 63/734,968, filed on Dec. 17, 2024.

(51) Int. Cl. C11D 3/22; C11D 1/83; C11D 3/00; C11D 3/20; C11D 17/06

(52) U.S. Cl. CPC C11D 3/222; C11D 1/83; C11D 3/0026; C11D 3/2093; C11D 17/06; C11D 2111/12

(57) ABSTRACT

The present disclosure provides cleaning articles. The articles can be formed of a detergent composition, a film former, and a foam stabilizer. The detergent composition can comprise at least one surfactant. The film former can comprise a cellulose-based polymer. The cleaning article can be configured as a substantially solid foam structure that is soluble in aqueous liquid and substantially non-flowing at a temperature of about 80° C. or less when out of contact with the aqueous liquid.

### CROSS-REFERENCE TO RELATED APPLICATIONS

The present application claims priority to U.S. Provisional Patent Application No. 63/734,968, filed on Dec. 17, 2024, the entire contents of which are incorporated herein by reference.

### FIELD OF THE DISCLOSURE

The present disclosure relates to detergent formulations and articles for unit dose provision of the detergent formulations with improved binding capabilities during manufacture and improved dissolution during use, particularly when used with automatic laundry machines. The articles can comprise a detergent formulation configured as foam-based sheet materials, such as sheets formed of a water-soluble material.

### BACKGROUND

The use of water-soluble film carriers to deliver unit dosage amounts of laundry products is known, and detergents and bleaches have been sold in this form for many years. Known unit dose detergent articles can suffer from poor dissolution of the carrier material, and this can exacerbate poor dissolution properties of detergents retained by the carrier. This can result in wash cycles where a substantially undissolved carrier remains in the wash load or where residue is present due to detergents that were released from the article but not fully dissolved. On the other hand, known carrier materials that improve dissolution can suffer from poor binding of the detergents retained by the carrier, particularly in the binding of nonionic surfactants. This can result in the loss of cleaning components during manufacture, and decreased performance of the unit dose detergent article during use.

There is still a desire and a need to provide laundry detergent compositions that are in unit dose forms. There is also a desire and need for unit dose laundry compositions and articles that achieve improved solubility in laundry machines while maintaining the consumer expected efficacy of current liquid laundry detergents and sachets. Furthermore, there is a desire to improve the binding capability of the water-soluble film carriers of unit dose laundry detergent compositions during manufacture in such a way as to still optimize full dissolution during the wash.

### SUMMARY OF THE DISCLOSURE

The present disclosure relates to laundry detergent articles. A laundry detergent article as described herein can be provided as a unit dose article in that the article is intended to provide, as an individual unit, a sufficient quantity of detergent for carrying out laundering of a typical load in standard washing machines. The articles comprise a detergent and are in the form of a water soluble sheet material configured to provide the unit dose. More particularly, a unit dose laundry detergent article according to the present disclosure can be defined by a single sheet, formed of a single layer of material. An individual sheet can be specifically configured as a substantially solid foam that comprises a water soluble material. The sheet can include pores that provide for improved infiltration of water for diffusion of the sheet material during use. The configuration of the disclosed laundry detergent article can provide multiple advantages, such as improving diffusion of the detergent, increasing stability during storage, and beneficially providing additive cleaning efficacy.

Compositions defining the laundry article can be specifically formulated to exhibit high solubility in water so that the sheet materials can quickly disperse in a wash water to provide the detergent function to articles being washed. This combination of high solubility and high stability can be difficult to achieve, and the present disclosure can relate to specific formulations that impart this combination of properties. In certain embodiments, this particularly can comprise formulations wherein a detergent composition is combined with a film former and a foam stabilizer to form a stable, foam structure.

In one or more embodiments, a cleaning article according to the present disclosure can comprise: a detergent composition comprising at least one surfactant; a film former comprising a cellulose-based polymer; and a foam stabilizer; wherein the cleaning article is configured as a substantially solid foam structure that is soluble in an aqueous liquid and is substantially non-flowing at a temperature of about 80° C. or less when out of contact with the aqueous liquid. In further embodiments, the cleaning article can be defined in relation to one or more of the following statements, which can be combined in any number and/or order.

The cleaning article can comprise about 20% to about 80% by weight surfactants.

The at least one surfactant can comprise non-ionic surfactants.

The at least one surfactant can comprise non-ionic surfactants and anionic surfactants.

The cleaning article can comprise about 1% to about 3% by weight foam stabilizer.

The foam stabilizer can comprise one or more citrate esters.

The foam stabilizer can comprise triethyl citrate, triethyl o-acetyl citrate, tributyl citrate, or combinations thereof.

The cellulose-based polymer can be a polysaccharide.

The cellulose-based polymer can comprise hydroxypropyl methylcellulose (HPMC), methyl cellulose low-viscosity (MCLV), xanthan gum, pullulan, or combinations thereof.

The cleaning article can comprise about 5% to about 15% by weight polysaccharide.

The cleaning article can exclude polyvinyl alcohols.

The cleaning article can have a density of about 0.2 g/cm³ to about 0.4 g/cm³.

The cleaning article can further comprise an absorbent.

The absorbent can comprise a clay-based material, a silica-based material, a starch, or combinations thereof.

The cleaning article can be soluble in the aqueous liquid at a temperature of about 10° C. to about 30° C. in a time of about 2 minutes to about 10 minutes.

The detergent composition can further comprise one or more materials selected from the group consisting of enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), and laundry booster(s).

The cleaning article can be further configured as a sheet having a thickness, and a length and a width that are each greater than the thickness.

In one or more embodiments, a cleaning article according to the present disclosure can comprise: a detergent composition comprising at least one surfactant; a film former comprising a cellulose-based polymer; and a foam stabilizer; wherein the cleaning article is configured as a substantially solid foam structure; and wherein the Hansen Solubility Parameter Distance (Ra) of the film former and the at least one surfactant is about 20 MPa^{1/2} or less. In further embodiments, the cleaning article can be defined in relation to one or more of the following statements, which can be combined in any number and/or order.

The Ra of the film former and the at least one surfactant can be in a range of about 7 MPa^{1/2} to about 13 MPa^{1/2}.

The substantially solid foam structure can be soluble in an aqueous liquid and is substantially non-flowing at a temperature of about 80° C. or less when out of contact with the aqueous liquid.

The cleaning article can comprise about 20% to about 80% by weight surfactants.

The at least one surfactant can comprise non-ionic surfactants.

In one or more further embodiments, a cleaning article of the present disclosure can comprise: a detergent composition comprising at least one surfactant; a film former comprising a water-soluble polymer; and a foam stabilizer; wherein the cleaning article is configured as a substantially solid foam structure that is soluble in an aqueous liquid and is substantially non-flowing at a temperature of about 80° C. or less when out of contact with the aqueous liquid. In further embodiments, the cleaning article can be defined in relation to one or more of the following statements, which can be combined in any number and/or order.

The cleaning article can comprise about 40% to about 80% by weight surfactants.

The at least one surfactant can comprise non-ionic surfactants.

The at least one surfactant can comprise non-ionic surfactants and anionic surfactants.

The cleaning article can comprise at least about 2% by weight foam stabilizer.

The foam stabilizer can be a silica-based material.

In one or more further embodiments, the present disclosure can provide a method of preparing a cleaning article. As a non-limiting example, such a method can comprise: combining a detergent composition comprising 20-80% by weight surfactants with a water soluble, cellulose-based polymer; aerating the combined detergent composition and water soluble, cellulose-based polymer to form a foam; heating the foam to remove water retained therein; and cooling the foam to form a substantially solid foam structure. In further embodiments, the method can be defined in relation to one or more of the following statements, which can be combined in any number and/or order

One or both of the combining and the aerating can be carried out with mixing and/or whisking.

The substantially solid foam structure can have a density of about 0.2 g/cm³ to about 0.4 g/cm³.

The substantially solid foam structure can be substantially non-flowing at a temperature up to 80° C. when out of contact with an aqueous liquid.

The method can further comprise casting the flowable foam so that the substantially solid foam structure exhibits a defined shape of defined dimensions.

Further to the above, the present disclosure can provide a cleaning article prepared according to the method described above or otherwise discussed herein. In particular, the cleaning article prepared by the method can exhibit any of the characteristics otherwise exhibited by the cleaning articles described herein, such as being substantially completely water-soluble at a temperature of about 15° C. and a temperature of about 30° C. in a time of about 0.5 minutes to about 10 minutes.

### BRIEF DESCRIPTION OF THE DRAWINGS

Having thus described aspects of the disclosure in the foregoing general terms, reference will now be made to the accompanying drawings, which are not necessarily drawn to scale. The drawings are examples only, and should not be construed as limiting the disclosure.

FIG. 1 is a graph illustrating dissolution efficiency for cleaning articles prepared using different foam stabilizers according to an example embodiment of the present disclosure.

FIG. 2 is a graph illustrating the capability of film formers of cleaning articles to bind nonionic surfactants according to an example embodiment of the present disclosure.

FIG. 3 is a graph illustrating non-ionic surfactant binding stability of cleaning articles as a function of stain removal efficacy according to an example embodiment of the present disclosure.

FIG. 4 is a graph illustrating HSP distance as a function of grease retention of water soluble polymer/surfactant formulations in cleaning articles according to an example embodiment of the present disclosure.

### DETAILED DESCRIPTION OF THE DISCLOSURE

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one or more embodiments, the present disclosure provides cleaning articles, such as, for example, laundry detergents. The cleaning articles can be provided as substantially solid articles so that they are capable of being handled directly by a consumer and substantially retain their shape throughout such handling. A cleaning article according to the present disclosure can be defined as a single object that can be a single mass of a substantially uniform composition. “Uniform” as used herein indicates that the components are evenly mixed so as to be homogenously distributed. In certain embodiments, a cleaning article of the present disclosure can be shaped so as to be substantially sheet-like and thus may be defined by a single layer which is shaped like a sheet.

The structural arrangement of the disclosed cleaning articles can increase efficiency of the cleaning article as, for example, a laundry detergent. For example, the high surface area of the cleaning article, when arranged in a sheet form, can increase the rate of dissolution of the cleaning article. The dissolution rate of the cleaning article directly affects the efficiency and performance of the cleaning article. For example, providing for a faster release of the components of the cleaning article into the washing liquid can increase the likelihood that substantially the entirety of the cleaning article components are dispersed during the wash cycle to provide their individual cleaning functions. Furthermore, a faster dissolution rate can be more environmentally friendly due to a shortened wash cycle, resulting in less water and power usage during laundering.

The cleaning articles described herein can be provided in a variety of shapes and sizes. For example, the overall cleaning article when viewed from the top or bottom, can be substantially in the form of a square, rectangle, parallelogram, triangle, circle, or other shape, but conveniently may have a rectangular or square shape when viewed normally to the plane of its two longest dimensions. A rectangular or square cleaning article may be more easily manufactured than other configurations when using conventional packaging equipment.

The disclosed cleaning articles can be provided in different sizes and weights (e.g., small, medium, large) to accommodate different consumer needs. The sizes can correspond to a recommended detergent dose for laundry fabric loads or levels of soil. The weight and dimensions of the cleaning articles can be balanced to ensure quick and complete dissolution of the article in the wash water. In various embodiments, the cleaning articles described herein can have a length defined by an upper length of 30 cm and a lower length of 5 cm, the length including all possible ranges bounded by the upper length and the lower length (e.g., 5 cm to 30 cm, 10 cm to 25 cm, etc.) and, as such, every whole number from 5 to 30 (or fractions thereof) is expressly included in this disclosure for defining upper and lower boundaries of the encompassed ranges. Likewise, the length can be “at least” any of the values within the above range or can be “less than” any of the values within the above range.

In various embodiments, the cleaning articles can have a width defined by an upper width of 20 cm and a lower width of 3 cm, the width including all possible ranges bound by the upper width and the lower width (e.g., 3 cm to 20 cm, 5 cm to 15 cm, etc.). Likewise, the width can be “at least” any of the values within the above range or can be “less than” any of the values within the above range. In some embodiments, the cleaning article can have a ratio of length to width (i.e., L:W) of about 1:1 to about 10:1, about 1:1 to about 5:1, or about 1: to about 3:1.

In various embodiments, the cleaning articles can have a thickness defined by an upper thickness of 20 mm and a lower thickness of 2 mm, the thickness including all possible ranges bound by the upper thickness and the lower thickness (e.g., 2 mm to 20 mm, 5 mm to 15 mm, etc.) and, as such every whole number between 2 and 20 (or fractions thereof) is expressly included in this disclosure for defining upper and lower boundaries of the encompassed ranges. Likewise, the thickness can be “at least” any of the values within the above range or can be “less than” any of the values within the above range. In some embodiments, the cleaning article can be configured to have a length and a width that are each greater than the thickness. For example, the cleaning article can have a ratio of length to thickness (L:T) of about 10:1 to about 200:1, about 15:1 to about 100:1, or about 20:1 to about 80:1. Ratios of width to thickness (W:T) can be within the same ranges as the L:T ratios with the W:T ratio being equal to or less than the L:T ratio.

The structural arrangement of the disclosed cleaning articles can increase efficiency of the cleaning article as, for example, a laundry detergent. For example, the high surface area of the cleaning article, when arranged in a sheet form, can increase the rate of dissolution of the cleaning article. The dissolution rate of the cleaning article directly affects the efficiency and performance of the cleaning article. For example, providing for a faster release of the components of the cleaning article into the washing liquid can increase the likelihood that substantially the entirety of the cleaning article components are dispersed during the wash cycle to provide their individual cleaning functions. Furthermore, a faster dissolution rate can be more environmentally friendly due to a shortened wash cycle, resulting in less water and power usage during laundering.

As such, a cleaning article according to the present disclosure can be configured as a substantially solid foam. A solid foam may be rigid. A solid foam may be flexible. A solid foam may be compressible. In any state, a solid foam is a foam that does not dissipate or reduce to a non-foamed state after achieving the solid state. A solid foam structure useful as a cleaning article can comprise a detergent composition and a water soluble film former or carrier, which are mixed and processed to achieve a flowable foam. Such processing can comprise aeration of a non-foamed, viscous liquid, gel, slurry, or paste to incorporate air. Processing can further comprise drying the composition so that the incorporated or entrained air forms pores, as noted herein. Accordingly, the phrase “solid foam” indicates a structure that is characterized by the presence of pores, which can be discrete pores or interconnecting pores, achieved by the specific incorporation of a gas (e.g., air) into the composition when in a liquid or flowable form so that the pores remain upon solidification of the composition into a solid or non-flowable form.

A solid foam structure useful as a cleaning article disclosed herein will be substantially or completely non-flowing at a temperature of about 80° C. or less and at ambient pressure when out of contact with an aqueous liquid. In some embodiments, the foam structure will be substantially or completely non-flowing at a temperature of about 70° C. or less, about 60° C. or less, or about 50° C. or less at ambient pressure when out of contact with an aqueous liquid. Completely non-flowing is understood to mean at least about 99.9% by weight of the cleaning article retains a solid shape, and substantially non-flowing is understood to mean at least about 97.5%, at least about 98%, at least about 98.5%, at least about 99%, or at least about 99.5% by weight of the cleaning article retains a solid shape.

The solid foam structure likewise will exhibit a solubility in water as otherwise described herein. In some embodiments, the foam structure will be substantially or completely water soluble, such as, for example, at a temperature of about 30° C. or less in a time of about 10 minutes or less. In other examples the foam structure can be substantially or completely water soluble at a temperature of about 20° C. or less, about 15° C. or less, or in a range of about 10° C. to about 30° C., in a time of about 10 minutes or less, about 7 minutes or less, about 5 minutes or less, or in a range of about 2 minutes to about 10 minutes. Completely water soluble is understood to mean at least 99.9% by weight of the film former is solubilized in the water, and substantially water soluble is understood to mean at least 98%, at least 98.5%, at least 99%, or at least 99.5% of the film former is solubilized in the water.

Dissolution time of the disclosed cleaning articles is directly affected by the permeability, porosity (and corresponding degree of aeration), thickness, and/or other parameters of the solid foam structure. In various embodiments, the solid foam structure described herein can have a permeability which ensures that liquid from the wash water permeates the cleaning article and provides a desirable rate of dissolution. In various embodiments, the solid foam structure can have pore sizes configured to achieve the desired permeability. Porosity can be determined qualitatively by a visual examination of the pore size of the solid foam structure. In some embodiments, the porosity can be defined in relation to the average size of pores within the solid foam structure. More commonly, however, porosity is instead measured by sheet density (mass per volume), which also offers higher accuracy. In the disclosed cleaning articles, porosity can be defined as the fraction of void space in the material, where the void contains air. Specifically, porosity can be determined by dividing the volume of the voids within the solid foam structure by the total volume of the solid foam structure. In one or more embodiments, the porosity (mass per volume) can range from about 0.2 g/cm³ to about 0.4 g/cm³.

Cleaning articles configured as a substantially solid foam structure can comprise a wide variety of components or materials that are useful in the laundering of fabrics and, more specifically, clothing items. The cleaning articles can be characterized as comprising one or more cleaning components with it being understood that the phrase “cleaning component” indicates that it is a component useful in a laundry detergent composition. The one or more cleaning components can be selected from the group consisting of surfactant(s), enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), disintegrant(s), such as sodium starch glycolate, and laundry booster(s). Particularly, the cleaning articles can comprise a plurality of components and preferably in a substantially concentrated form. As used herein, “concentrated” indicates that the detergent composition is not diluted, or is only minimally diluted, by non-detergent materials, such as water. A concentrated cleaning composition specifically will comprise less than 10%, less than 5%, less than 2%, or less than 1% by weight of non-detergent materials. A non-detergent material is any material that is not typically included in detergent compositions for the purpose of providing a cleaning or detergency purpose. As non-limiting examples, a concentrated detergent or cleaning composition can be a composition wherein at least 90%, at least 95%, at least 98%, or at least 99% by weight of the composition is only components selected from the previously provided list in any number.

A wide variety of anionic and/or nonionic surfactants can be used according to the present disclosure. In some embodiments, a suitable anionic surfactant may include one or more salts (e.g., sodium, potassium, ammonium, and substituted ammonium salts such as mono-, di- and triethanolamine salts) of anionic sulfates, sulfonates, carboxylates, and sarcosinates. Exemplary anionic sulfates can include linear and/or branched primary and secondary alkyl sulfates, alkyl ethoxysulfates, fatty oleoyl glycerol sulfates, alkyl phenol ethylene oxide ether sulfates, C₅-C₁₇ acyl-N—(C₁-C₄ alkyl) and —N—(C₁-C₂ hydroxyalkyl) glucamine sulfates, and sulfates of alkylpolysaccharides, such as alkylpolyglucoside sulfates. Exemplary alkyl sulfates can include linear and branched primary C₁₀-C₁₈ alkyl sulfates. Exemplary alkyl ethoxysulfate surfactants can include C₁₀-C₁₈ alkyl sulfates that have been ethoxylated with from 0.5 to 20 moles of ethylene oxide per molecule. Exemplary anionic sulfonate surfactants can include C₅-C₂₀ linear alkylbenzene sulfonates, salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Exemplary anionic carboxylates can include alkyl ethoxy carboxylates, and alkyl polyethoxy polycarboxylates. In some embodiments, preferred anionic surfactants can include various sulfates (e.g., alkyl ether sulfates, such as laureth sulfate salts), alkyl ester sulfonates, and alkylbenzene sulfonate (e.g., C₅ to C₂₀ or C₁₀ to C₁₆). Non-limiting examples of anionic surfactants that may be used herein include dodecylbenzene sulfonic acid (DBSA), such as that available under the tradename “Biosoft® S-118,” sodium laureth sulfate (SLES), sodium lauryl sulfate (SLS), methyl ester sulfonate (MES), and sodium C₁₀₋₁₆ alkylbenzene sulfonate (LAS). In certain embodiments, ethoxylated anionic surfactants may be utilized and may comprise a limited number of moles of ethylene oxide groups. For example, an alkyl ether sulfate anionic surfactant may comprise less than 5 moles, or less than 4 moles of ethylene oxide groups, such as 1 to 4 or 2 to 3 ethylene oxide groups.

In some embodiments, a suitable nonionic surfactant may include alkyl ethoxylate condensation products of aliphatic alcohols with from 1 to 25 moles of ethylene oxide wherein the alkyl chain of the aliphatic alcohol can either be straight or branched, primary or secondary, and generally contains from 6 to 22 carbon atoms. Further suitable nonionic surfactants can include water soluble ethoxylated C₆-C₁₈ fatty alcohols and C₆-C₁₈ mixed ethoxylated/propoxylated fatty alcohols. For example, the ethoxylated fatty alcohols can be C₁₀-C₁₈ ethoxylated fatty alcohols with a degree of ethoxylation of from 3 to 20. In some embodiments, mixed ethoxylated/propoxylated fatty alcohols can have an alkyl chain length of from 10 to 18 carbon atoms, a degree of ethoxylation of from 3 to 30, and a degree of propoxylation of from 1 to 10. In further embodiments, suitable nonionic surfactants can include those formed from the condensation of ethylene oxide with a hydrophobic base formed by the condensation of propylene oxide with propylene glycol. Examples of compounds of this type include certain of the commercially-available Pluronic™ surfactants, marketed by BASF. Further, suitable nonionic surfactants can include those formed from the condensation of ethylene oxide with the product resulting from the reaction of propylene oxide and ethylenediamine. Examples of this type of nonionic surfactant include certain of the commercially available Tetronic™ compounds, marketed by BASF. In certain embodiments, suitable nonionic surfactants can be selected, for example, from various alcohol ethoxylates. In some embodiments, the nonionic surfactant can be defined in relation to the alcohol chain length and/or the number of ethoxylate groups present in the molecule. For example, the nonionic surfactant can comprise an alcohol ethoxylate formed from an alcohol with a carbon chain length of 3 to 20 carbon atoms, 5 to 20 carbon atoms, 7 to 19 carbon atoms, 9 to 18 carbon atoms, 10 to 17 carbon atoms, or 12 to 15 carbon atoms. As a further example, the nonionic surfactant can comprise an alcohol ethoxylate having 2 to 10, 4 to 9, or 6 to 8 moles of ethylene oxide per mole of alcohol. Non-limiting examples of nonionic surfactants that may be used herein include ethoxylated alcohols (AE) (C₁₂₋₁₅ alcohols, in particular), such as those available under the tradename NEODOL®, lauryl or myristyl glucosides (APG), and polyoxyethylene alkylethers (2° AE).

Surfactants can be present in the disclosed cleaning articles in an amount greater than 20% by weight based on the total weight of the cleaning article. For example, in some embodiments, surfactants can be present in an amount of greater than 30% by weight, greater than 35% by weight, greater than 40% by weight, greater than 45% by weight, greater than 50% by weight, greater than 55% by weight, greater than 60% by weight, greater than 65% by weight, or greater than 70% by weight. In other embodiments, surfactants can be present in an amount ranging from about 20% to about 80% by weight based on the total weight of the cleaning article, for example from about 20% to about 70% by weight, from about 30% to about 50% by weight, or from about 40% to about 70% by weight.

Anionic surfactants can be present in the disclosed cleaning articles in an amount greater than about 10% by weight based on the total weight of the cleaning article. For example, in some embodiments anionic surfactants can be present in an amount greater than about 15% by weight, greater than 20% by weight, or greater than 25% by weight. In other embodiments, anionic surfactants can be present in an amount ranging from about 10% by weight to about 30% by weight based on the total weight of the cleaning article, for example from about 10% to about 20% by weight, from about 15% to about 20% by weight, or from about 20% to about 25% by weight.

Nonionic surfactants can be present in the disclosed cleaning articles in an amount greater than about 10% by weight based on the total weight of the cleaning article. For example, in some embodiments, nonionic surfactants can be present in an amount greater than about 15% by weight, greater than 20% by weight, greater than 25% by weight, or greater than 35% by weight. In other embodiments, nonionic surfactants can be present in an amount ranging from about 10% by weight to about 50% by weight based on the total weight of the cleaning article, for example from about 10% to about 30% by weight, from about 15% to about 40% by weight, from about 15% to about 20% by weight, from about 20% to about 25% by weight, or from about 35 to about 50% by weight.

Cleaning articles of the present disclosure can include a foam stabilizer configured to improve the physical and chemical stability of the solid foam structure. Foam stabilizers can include one or a plurality of materials that are effective to decrease interfacial tension of a gas/liquid and thereby reduce the tendency of coalescence and prevent collapse of the air pockets or bubbles in the foam. In some embodiments, the foam stabilizer can comprise one or more citrate esters. The citrate esters can include any form of citric acid that is esterified to include a plurality of alkyl chains of the same or different chain lengths. For example, the foam stabilizer can include triethyl citrate, triethyl o-acetyl citrate, tributyl citrate, or combinations thereof. In some embodiments, the foam stabilizer can be present in the disclosed cleaning articles in an amount ranging from about 0.1% to about 8%, about 0.5% to about 5%, or about 1% to about 3% by weight based on the total weight of the cleaning article.

The disclosed cleaning articles can also include an absorbent configured to improve the physical and chemical stability of the substantially solid foam structure. In some embodiments, the absorbent can comprise a clay-based material, a silica-based material, a starch, or combinations thereof. For example, the absorbent can include bentonite, silica powder, such as that available under the trade name SIPERNAT D 13, rice starch, or combinations thereof. In some embodiments, the absorbent can be present in the disclosed cleaning articles in an amount ranging from about 0.1% to about 10%, about 0.5% to about 8%, or about 1% to about 6% by weight based on the total weight of the cleaning article.

A cleaning article as disclosed herein can further include a film former. In some embodiments, the film former comprises a water soluble polymer, such as, for example, a cellulose-based polymer. The cellulose-based polymer can be a polysaccharide, such as hydroxypropyl methylcellulose (HPMC), methyl cellulose low-viscosity (MCLV), xanthan gum, pullulan, or combinations thereof. In one or more embodiments, the film former may include a content of a polyvinyl alcohol. Alternatively, in one or more embodiments, a polyvinyl alcohol water soluble polymer may be expressly excluded from the cleaning article disclosed herein. In some embodiments, the film former can be present in the disclosed cleaning articles in an amount of about 2% to about 40% by weight based on the total weight of the cleaning article, such as in the range of about 5% to about 20%, with a range of about 7% to about 15% being preferred.

A film former useful for cleaning articles can be configured to bind anionic and/or nonionic surfactants present in the detergent composition such that in the formation of a solid foam structure described herein, anionic surfactants and/or nonionic surfactants are substantially or completely retained. As mentioned above and detailed further below, in the formation of a solid foam structure, a film former described herein is mixed with a detergent composition described herein and processed to achieve a flowable foam. The flowable foam can then be dried to form a substantially solid foam structure. The substantially solid foam structure may retain substantially or completely all of the anionic surfactants and/or nonionic surfactants present in the flowable foam. Substantially retained is known to indicate that at least about 97% by weight of anionic surfactant and/or nonionic surfactant is retained by the cleaning article, such as about 97.5% or greater, about 98% or greater, or about 98.5% or greater, such as up to a maximum amount of about 99.99% by weight. Completely retained is likewise known to indicate that about 99% or greater by weight of anionic surfactant and/or nonionic surfactant is retained by the cleaning article, such as about 99% or greater, about 99.5% or greater, or about 99.5% or greater by weight is retained.

In some embodiments, the film former can be selected based on the similarity of its solubility parameters in comparison to the solubility parameters of at least one solvent present in the detergent composition. The similarity of the solubility parameters can be calculated, for example, by using the Hansen Solubility Parameters (HSP) of each the film former and at least one surfactant, and using these values in the HSP distance equation, shown in Formula (1).

$${Ra}^{2} = 4 {( δ D 1 - δ D 2 )}^{2} + {( δ P 1 - δ P 2 )}^{2} + {( δ H 1 - δ H 2 )}^{2} \qquad ( 1 )$$

In Formula (1), Ra equals the HSP distance; δD1 equals the energy from dispersion forces between molecules of the film former; δD2 equals the energy from dispersion forces between molecules of the at least one surfactant; δP1 equals the energy from dipolar intermolecular forces between molecules of the film former; δP2 equals the energy from dipolar intermolecular forces between molecules of the at least one surfactant; δH1 equals the energy from hydrogen bonds between molecules of the film former; and δH2 equals the energy from hydrogen bonds between molecules of the at least one surfactant.

Values of δD1, δD2, δP1, δP2, δH1, and δH2 (HSP values) for an individual compound can be accessed through the Hansen Solubility Parameter in Practice (HSPiP) software, by consulting scientific literature or handbooks that list HSP data for various compounds, or by calculating each value based on the unit structures of each molecule. Alternatively, for a combination of multiple compounds, HSP values can be estimated using molecular structure techniques. For example, to estimate the δD of a combined first and second surfactant, molecular values of each the first surfactant and the second surfactant can be calculated according to Formula (2).

$$δ {D}_{comb} = M 1 ( F 1 * δ d 1 ) + M 2 ( F 2 * δ d 2 ) \qquad ( 2 )$$

In Formula (2), M1 is the mass fraction of the first surfactant based on the total mass of the first surfactant and the second surfactant combined; M2 is the mass fraction of the second surfactant based on the total mass of the first surfactant and the second surfactant combined; F1 is the mole fraction of the first surfactant based on the total moles of the first surfactant and the second surfactant combined; F2 is the mole fraction of the second surfactant based on the total moles of the first surfactant and the second surfactant combined; δd1 is the energy from dispersion forces between molecules of the first surfactant; and δd2 is the energy from dispersion forces between molecules of the second surfactant.

As another example, to estimate the SP of a combined first and second surfactant, molecular values of each the first surfactant and the second surfactant can be calculated using Formula (3).

$$δ {P}_{comb} = M 1 ( F 1 * δ p 1 ) + M 2 ( F 2 * δ p 2 ) \qquad ( 3 )$$

In Formula (3), M1 is the mass fraction of the first surfactant based on the total mass of the first surfactant and the second surfactant combined; M2 is the mass fraction of the second surfactant based on the total mass of the first surfactant and the second surfactant combined; F1 is the mole fraction of the first surfactant based on the total moles of the first surfactant and the second surfactant combined; F2 is the mole fraction of the second surfactant based on the total moles of the first surfactant and the second surfactant combined; δp1 is the energy from dipolar intermolecular forces between molecules of the first surfactant; and δp2 is the energy from dipolar intermolecular forces between molecules of the second surfactant.

As a further example, to estimate 8H of a combined first and second surfactant, molecular values of each the first surfactant and the second surfactant can be calculated using Formula (4).

$$δ {H}_{comb} = M 1 ( F 1 * δ h 1 ) + M 2 ( F 2 * δ h 2 ) \qquad ( 4 )$$

In Formula (4), M1 is the mass fraction of the first surfactant based on the total mass of the first surfactant and the second surfactant combined; M2 is the mass fraction of the second surfactant based on the total mass of the first surfactant and the second surfactant combined; F1 is the mole fraction of the first surfactant based on the total moles of the first surfactant and the second surfactant combined; F2 is the mole fraction of the second surfactant based on the total moles of the first surfactant and the second surfactant combined; δh1 is the energy from hydrogen bonds between molecules of the first surfactant; and δh2 is the energy from hydrogen bonds between molecules of the second surfactant.

After calculating the HSP distance, the value of Ra is indicative of how similar the solubility parameters of the film former are to the solubility parameters of the at least one surfactant. For example, the smaller the value of Ra, the more similar the solubility parameters of the film former are to the solubility parameters of the at least one surfactant. Alternatively, the higher the value of Ra, the less similar the solubility parameters of the film former are to the solubility parameters of the at least one surfactant. In some embodiments, the Ra of the film former and the at least one surfactant is about 20 MPa^{1/2} (megapascals) or less, such as about 15 MPa^{1/2} or less, about 11 MPa^{1/2} or less, or in a range of about 7 MPa^{1/2} to about 13 MPa^{1/2}.

In one or more embodiments, the cleaning article as disclosed herein can include any one or more of the following components in any combinations thereof: hydroxypropyl methyl cellulose; glycerin; pullulan; propylene glycol; acrylic acid homopolymer; dodecylbenzene sulfonic acid; alcohol ethoxylate; monoethanolamine; cornstarch; triethyl citrate; sorbitol; methyl cellulose high volume; methyl cellulose low volume; xanthan gum; triethyl o-acetyl citrate; tributyl citrate; sodium laureth sulfate; dipropylene glycol (DPG); bentonite; silica powder; rice starch; and Steol® 25-3S/70FC [70% aqueous solution of Na-salt of C₁₂₋₁₅ (EO) 3 sulfate].

A cleaning article according to the present disclosure can be prepared by combining a cleaning composition as discussed herein with a film former, such as a water soluble, cellulose-based polymer, as discussed above. The film former can be first dissolved in a suitable solvent, such as water. The cleaning composition can be fully or partially dissolved in the solvent with the film former or can be fully or partially dispersed in the solvent with the film former. The combination of the detergent composition and the film former can result in the formation of a flowable detergent/polymer mixture. The flowable detergent/polymer mixture can then be aerated to form a flowable foam. Aerating can be achieved using any suitable method. In some embodiments, sufficient aeration may be achieved through use of a high speed mixer. In some embodiments, it may be useful to flow gas into the detergent/polymer mixture to accelerate the dispersing of gas pockets through the mixture. Air or an otherwise inert gas may be used for such purpose. As non-limiting examples, arrangements such as a mixer with a whisk attachment, a counter rotating sweep, a screw agitator, or an integral air flow induction system can be used to incorporate sufficient aeration. Suitable branded mixers include Hobart mixers, Tri-Mix™ Turbo-Shear™ mixing systems from Lee Industries, high shear mixers available from Charles Ross & Son company, or Kitchen Aid mixers. The flowable foam can then be dried and cooled to form a substantially solid foam structure. Drying can include heating, such as up to a temperature of about 80° C., up to about 70° C., or up to about 60° C. for a time period. In various embodiments, the cleaning articles as disclosed herein can be prepared according to the preceding method. The cleaning articles according to the present disclosure and methods of preparation thereof include and are further defined by the examples set forth following.

### EXPERIMENTAL

### Example 1

A series of samples using cellulose-based polymers and varying concentrations of detergent compositions were formulated as flowable foam mixtures, dried for about 4 hours at 50° C., and then cooled for about 0.5 hours at ambient temperature to assess the state of the structure formed thereby. Two sample compositions using hydroxypropyl methyl cellulose (HPMC) are shown in TABLE 1, and three sample compositions using methyl cellulose high-velocity (MCHV) are shown in TABLE 2. The observations of the state of each sample are illustrated in TABLE 3.

TABLE 1

| | SK-5738-95H | SK-5738-95I |
|---|---|---|
| Component | (Wt. %) | (Wt. %) |
| HPMC | 7.3% | 7.4% |
| Glycerin | 12.2% | 12.3% |
| Biosoft ® | 24.4% | 24.7% |
| Neodol ® | 18.3% | 18.5% |
| MEA | 12.2% | 12.3% |
| Cornstarch | 24.4% | 24.7% |
| Triethyl Citrate | 1.2% | 0.0% |

TABLE 2

| | SK-5738-95J | SK-5738-95K | SK-5738-95L |
|---|---|---|---|
| Component | (Wt. %) | (Wt. %) | (Wt. %) |
| MCHV | 7.4% | 2.6% | 2.6% |
| Glycerin | 12.3% | 13.0% | 12.8% |
| Biosoft ® | 24.7% | 26.0% | 25.6% |
| Neodol ® | 18.5% | 19.5% | 19.2% |
| MEA | 12.3% | 13.0% | 12.8% |
| Cornstarch | 24.7% | 26.0% | 25.6% |
| Triethyl Citrate | 0.0% | 0.0% | 1.3% |

TABLE 3

| Sample SK-5738-95 | Observation |
|---|---|
| H | Formed a solid foam structure |
| I | Formed a solid foam structure |
| J | Did not form a solid foam structure |
| K | Did not form a solid foam structure |
| L | Did not form a solid foam structure |

The observations of TABLE 3 in view of the data of TABLE 1 and TABLE 2 is indicative that HPMC is more capable of binding increased concentrations of nonionic surfactants than MCHV. The total concentration of surfactants in each sample is the combined weight percent of Biosoft® and Neodol®.

The HPMC samples were then assessed for dissolution efficiency. A sample of 1 g was added to 250 mL of DI water and stirred at a rotating speed of 250 rpm. The water temperature was 10° C. The dissolution data is shown below in TABLE 4.

TABLE 4

| Sample SK-5738-95 | Dissolution Time | Residue (Wt. %) |
|---|---|---|
| H | >10 minutes | 29.0% |
| I | >10 minutes | 68.7% |

Sample SK-5738-95H, which included a concentration of triethyl citrate, demonstrated the best degree of dissolution as shown by the lower amount of residue remaining after dissolution relative to the remaining sample.

### Example 2

A series of samples using a modified formulation of sample SK-5738-95H were assessed for dissolution efficiency. The modification of the SK-5738-95H formulation includes varying concentrations of sodium starch glycolate. Four sample compositions are shown below in TABLE 5. A sample of 1 g was added to 250 mL of DI water and stirred at a rotating speed of 250 rpm for 10 minutes. The water temperature was 10° C. The resulting dissolution data is shown below in TABLE 6.

TABLE 5

| | SK-5738-96A | SK-5738-96B | SK-5738-96C | SK-5738-96D |
|---|---|---|---|---|
| Component | (Wt. %) | (Wt. %) | (Wt. %) | (Wt. %) |
| HPMC | 9.0% | 9.0% | 9.0% | 9.0% |
| Glycerin | 14.9% | 14.9% | 14.9% | 14.9% |
| Biosoft ® | 14.9% | 14.9% | 14.9% | 14.9% |
| Neodol ® | 14.9% | 14.9% | 14.9% | 14.9% |
| MEA | 14.9% | 14.9% | 14.9% | 14.9% |
| Cornstarch | 29.9% | 22.4% | 14.9% | 7.5% |
| SG | 0.0% | 7.5% | 14.9% | 22.4% |
| Triethyl Citrate | 1.5% | 1.5% | 1.5% | 1.5% |

TABLE 6

| Sample SK-5738-96 | Observation after 10 min. | Residue (Wt. %) |
|---|---|---|
| A | Incomplete dissolution | 20% |
| B | Incomplete dissolution | 56% |
| C | Incomplete dissolution | 40% |
| D | Incomplete dissolution | 54 |

Although none of the samples were fully dissolved after 10 minutes of stirring, sample SK-5738-96A, which included the smallest (0%) concentration of SG, demonstrated the best degree of dissolution as shown by the lower amount of residue remaining after dissolution relative to the remaining samples.

### Example 3

A series of samples using varying concentrations of water soluble polymers and varying concentrations of detergent compositions were formulated as flowable foam mixtures, dried for about 4 hours at 50° C., and then cooled for about 0.5 hours at ambient temperature to assess the state of the structure formed thereby. Two sample compositions using HPMC are shown in TABLE 7, two sample compositions using polyvinyl alcohol (PVOH) are shown in TABLE 8, and one sample using xanthan gum is shown in TABLE 9. The observations of the state of each sample are illustrated in TABLE 10.

TABLE 7

| Component | SK-5738-98A (Wt. %) | SK-5738-98B (Wt. %) |
|---|---|---|
| HPMC | 7.2% | 9.4% |
| Polyethylene Glycol | 12.0% | 15.6% |
| Glycerin | 2.4% | 0.0% |
| Biosoft ® | 24.1% | 15.6% |
| Neodol ® | 16.9% | 10.9% |
| MEA | 12.0% | 15.6% |
| Cornstarch | 24.1% | 31.3% |
| Triethyl Citrate | 1.2% | 1.6% |

TABLE 8

| Component | SK-5738-99A (Wt. %) | SK-5738-99B (Wt. %) |
|---|---|---|
| PVOH | 9.4% | 7.2% |
| Polyethylene Glycol | 15.6% | 12.0% |
| Glycerin | 0.0% | 2.4% |
| Biosoft ® | 15.6% | 24.1% |
| Neodol ® | 10.9% | 16.9% |
| MEA | 15.6% | 12.0% |
| Cornstarch | 31.3% | 24.1% |
| Triethyl Citrate | 1.6% | 1.2% |

TABLE 9

| Component | SK-5738-104A (Wt. %) |
|---|---|
| Xanthan gum | 7.2% |
| Polyethylene Glycol | 12.0% |
| Glycerin | 2.4% |
| Biosoft ® | 24.1% |
| Neodol ® | 16.9% |
| MEA | 12.0% |
| Cornstarch | 24.1% |
| Triethyl Citrate | 1.2% |

TABLE 10

| Sample | Observation |
|---|---|
| SK-5738-98A | Formed a solid foam structure |
| SK-5738-98B | Formed a solid foam structure |
| SK-5738-99A | Did not form a solid foam structure |
| SK-5738-99B | Did not form a solid foam structure |
| SK-5738-104A | Formed a solid foam structure |

The observations of TABLE 10 in view of the compositions of TABLE 1 and TABLE 2 is indicative that cellulose-based polymers are more capable of binding increased concentrations of nonionic surfactants than PVOH. The total concentration of surfactants in each sample is the combined weight percent of Biosoft® and Neodol®.

### Example 4

A series of samples using varying concentrations of water soluble polymers and varying concentrations of detergent compositions were formulated as 4 cm×4 cm flowable foam mixtures, placed between filter papers, and dried for 1.5 hours at 50° C. to assess the binding capability of each water soluble polymer. The formulation of the samples corresponds with samples SK-5738-98A, SK-5738-99B, SK-5738-104A disclosed in TABLES 7-9 above. Additionally sample SK-5738-100A was tested, the formulation of which is shown below in TABLE 11. The mass of the filter papers was measured before and after heating to calculate the grease (nonionic surfactant) retention of each sample. The grease retention data is shown below in TABLE 12.

TABLE 11

| Component | SK-5738-100A (Wt. %) |
|---|---|
| PVOH | 20.6% |
| Polyethylene Glycol | 10.3% |
| Glycerin | 2.1% |
| Biosoft ® | 20.6% |
| Neodol ® | 14.4% |
| MEA | 10.3% |
| Cornstarch | 20.6% |
| Triethyl Citrate | 1.0% |

TABLE 12

| | Sample | Initial | Final Filter | Grease |
|---|---|---|---|---|
| | Mass | Filter | Mass | Absorbed |
| Sample | (g) | Mass (g) | (g) | (g) |
| SK-5738-98A | 1.3 | 1.71 | 1.74 | 0.03 |
| SK-5738-99B | 1.3 | 1.77 | 2.10 | 0.33 |
| SK-5738-100A | 1.3 | 1.68 | 1.88 | 0.2 |
| SK-5738-104A | 1.3 | 1.69 | 1.86 | 0.17 |

The data of TABLE 12 in view of the compositions of TABLES 7-9 and 11 is indicative that cellulose-based polymers are more capable of binding increased nonionic surfactant concentrations than PVOH. The total concentration of surfactants in each sample is the combined weight percent of Biosoft® and Neodol®.

### Example 5

A series of samples using a modified formulation of sample SK-5738-98A were assessed for dissolution efficiency. The modification of the SK-5738-9A formulation includes varying the type of citrate ester and varying the concentration of surfactants. Four sample compositions with high concentrations of surfactants are shown below in TABLE 13, and four sample compositions with low concentrations of surfactants are shown below in TABLE 14. A sample of 1 g was added to 250 mL of DI water and stirred at a rotating speed of 250 rpm for 10 minutes. The water temperature was 10° C. The resulting dissolution data is shown below in TABLE 15.

TABLE 13

| | SK-5738-101A | SK-5738-101B | SK-5738-101C | SK-5738-101D |
|---|---|---|---|---|
| Component | (Wt. %) | (Wt. %) | (Wt. %) | (Wt. %) |
| HPMC | 7.2% | 7.2% | 7.2% | 7.3% |
| Propylene | 12.0% | 12.0% | 12.0% | 12.2% |
| glycol | | | | |
| Glycerin | 2.4% | 2.4% | 2.4% | 2.4% |
| Biosoft ® | 24.1% | 24.1% | 24.1% | 24.4% |
| Neodol ® | 16.9% | 16.9% | 16.9% | 17.1% |
| MEA | 12.0% | 12.0% | 12.0% | 12.2% |
| Cornstarch | 24.1% | 24.1% | 24.1% | 24.4% |
| Triethyl Citrate | 1.2% | 0.0% | 0.0% | 0.0% |
| Triethyl O- | 0.0% | 1.2% | 0.0% | 0.0% |
| Acetyl Citrate | | | | |
| Tributyl Citrate | 0.0% | 0.0% | 1.2% | 0.0% |

TABLE 14

| | SK-5738-101E | SK-5738-101F | SK-5738-101G | SK-5738-101H |
|---|---|---|---|---|
| Component | (Wt. %) | (Wt. %) | (Wt. %) | (Wt. %) |
| HPMC | 9.4% | 9.4% | 9.4% | 9.5% |
| Propylene | 15.6% | 15.6% | 15.6% | 15.9% |
| glycol | | | | |
| Glycerin | 0.0% | 0.0% | 0.0% | 0.0% |
| Biosoft ® | 15.6% | 15.6% | 15.6% | 15.9% |
| Neodol ® | 10.9% | 10.9% | 10.9% | 11.1% |
| MEA | 15.6% | 15.6% | 15.6% | 15.9% |
| Cornstarch | 31.3% | 31.3% | 31.3% | 31.7% |
| Triethyl Citrate | 1.6% | 0.0% | 0.0% | 0.0% |
| Triethyl O- | 0.0% | 1.6% | 0.0% | 0.0% |
| Acetyl Citrate | | | | |
| Tributyl Citrate | 0.0% | 0.0% | 1.6% | 0.0% |

TABLE 15

| Sample SK-5738-101 | Observation after 10 min. | Residue (Wt. %) |
|---|---|---|
| A | Incomplete dissolution | 4% |
| B | Incomplete dissolution | 2% |
| C | Incomplete dissolution | 0% |
| D | Incomplete dissolution | 5% |
| E | Fully dissolved | 0% |
| F | Incomplete dissolution | 0% |
| G | Incomplete dissolution | 0% |
| H | Incomplete dissolution | 7% |

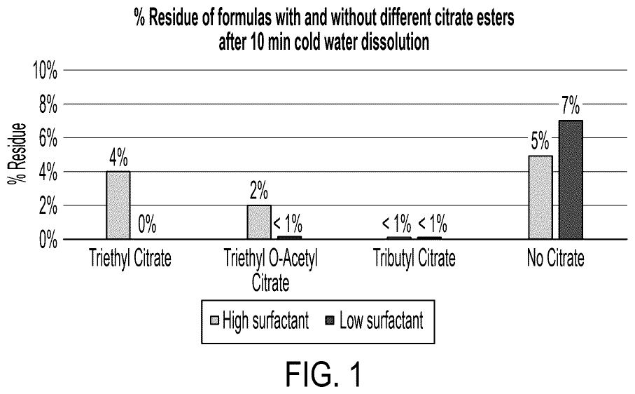

The data of TABLE 15 in view of the compositions of TABLES 13 and 14 is indicative that the presence of citrate esters in cleaning articles increases the degree of dissolution as shown by the lower amount of residue remaining relative to the remaining samples. This correlation is further illustrated in the graph of FIG. 1. The data and graph additionally indicate that the use of tributyl citrate increases the degree of dissolution of compositions with higher concentrations of surfactants as shown by the lower amount of residue remaining relative to the remaining samples. The total concentration of surfactants in each sample is the combined weight percent of Biosoft® and Neodol®.

### Example 6

A sample using an anionic surfactant in a detergent composition was assessed for dissolution efficiency. Three replicate sample compositions are shown below in TABLE 16. A sample of 1 g was added to 250 mL of DI water and stirred at a rotating speed of 250 rpm for 10 minutes. The water temperature was 10° C. The resulting dissolution data is shown below in TABLE 17.

TABLE 16

| | SK-5738-102A | SK-5738-102B | SK-5738-102C |
|---|---|---|---|
| Component | (Wt. %) | (Wt. %) | (Wt. %) |
| HPMC | 7.2% | 7.2% | 7.2% |
| Propylene glycol | 12.0% | 12.0% | 12.0% |
| Glycerin | 1.2% | 1.2% | 1.2% |
| Biosoft ® | 24.1% | 24.1% | 24.1% |
| Neodol | 18.1% | 18.1% | 18.1% |
| MEA | 12.0% | 12.0% | 12.0% |
| Cornstarch | 14.5% | 14.5% | 14.5% |
| Triethyl Citrate | 1.2% | 1.2% | 1.2% |
| SLS | 9.6% | 9.6% | 9.6% |

TABLE 17

| Sample SK-5738-102 | Observation after 10 min. | Residue (Wt. %) |
|---|---|---|
| A | Incomplete dissolution | <1% |
| B | Incomplete dissolution | <1% |
| C | Incomplete dissolution | 2% |

As indicated in Table 17, none of the samples were fully dissolved after 10 minutes of stirring. However, the data of TABLE 17 in view of the compositions of TABLE 16 is indicative that the presence of anionic surfactants in cleaning articles increases the degree of dissolution as shown by the lower amount of residue remaining relative to the samples of the other examples.

### Example 7

A series of samples using a cellulose-based polymer and varying concentrations of detergent compositions were assessed for dissolution efficiency. Four sample compositions are shown below in TABLE 18. A sample of 1 g was added to 250 mL of DI water and stirred at a rotating speed of 250 rpm. The water temperature was 10° C. The resulting dissolution data is shown below in TABLE 19.

TABLE 18

| | SK-5738-103A | SK-5738-103B | SK-5738-103C | SK-5738-103D |
|---|---|---|---|---|
| Component | (Wt. %) | (Wt. %) | (Wt. %) | (Wt. %) |
| HPMC | 7.23% | 7.23% | 7.23% | 8.28% |
| Propylene | 12.05% | 12.05% | 12.05% | 13.79% |
| glycol | | | | |
| Glycerin | 1.20% | 1.20% | 1.20% | 1.38% |
| Biosoft ® | 24.10% | 24.10% | 24.10% | 27.59% |
| Neodol ® | 18.07% | 18.07% | 18.07% | 20.69% |
| MEA | 12.05% | 12.05% | 12.05% | 13.79% |
| Cornstarch | 7.23% | 7.23% | 16.87% | 2.07% |
| Bentonite | 4.82% | 0.0% | 0.0% | 0.0% |
| Sipernat ® D13 | 0.0% | 4.82% | 0.0% | 0.0% |
| Tributyl Citrate | 0.0% | 0.0% | 0.60% | 0.0% |
| Rice starch | 0.0% | 0.0% | 0.0% | 4.83% |
| Triethyl Citrate | 1.20% | 1.20% | 0.60% | 0.69% |
| SLS | 12.05% | 12.05% | 7.23% | 6.90% |

TABLE 19

| Sample | | Residue |
|---|---|---|
| SK-5738-103 | Dissolution Time | (Wt. %) |
| A | 4 minutes 21 seconds +/− 20 seconds | 0% |
| B | 5 minutes 15 seconds +/− 20 seconds | 0% |
| C | 6 minutes 48 seconds +/− 20 seconds | 0% |
| D | 6 minutes 55 seconds +/− 20 seconds | 0% |

The data of TABLE 19 in view of the compositions of TABLE 18 is indicative that the presence of adsorbers, such as bentonite, Sipernat D 13, or rice starch increases the degree of dissolution as shown by the faster dissolution time and the lower amount of residue remaining relative to the samples of the other examples. The data of TABLE 19 in view of the compositions of TABLE 18 is further indicative that the presence of multiple citrate esters in cleaning articles increases the degree of dissolution as shown by the faster dissolution time and the lower amount of residue remaining relative to the samples of the other examples.

### Example 8

A series of samples using varying concentrations of silica with a water soluble polymer were formulated as flowable foam mixtures, placed between filter papers, and dried to assess the binding capability of each water soluble polymer. Four sample formulations are shown below in TABLES 20-23. The mass of the filter papers was measured before and after heating to calculate the grease retention of each sample. The grease retention data is shown below in TABLE 24.

TABLE 20
SG-5797-3-01

| Component | Wet Weight (g) | Dry Weight (g) | Wt. % |
|---|---|---|---|
| Water | 15 | 0 | 0% |
| PVOH 35% | 20 | 7 | 31.5% |
| Glycerin | 5 | 5 | 22.5% |
| Neodol ® | 10 | 10 | 44.9% |
| Silica | 0.25 | 0.25 | 1.1% |

TABLE 21
SG-5797-3-02

| Component | Wet Weight (g) | Dry Weight (g) | Wt. % |
|---|---|---|---|
| Water | 15 | 0 | 0% |
| PVOH 35% | 20 | 7 | 31.1% |
| Glycerin | 5 | 5 | 22.2% |
| Neodol ® | 10 | 10 | 44.5% |
| Silica | 0.5 | 0.5 | 2.2% |

TABLE 22
SG-5797-3-03

| Component | Wet Weight (g) | Dry Weight (g) | Wt. % |
|---|---|---|---|
| Water | 15 | 0 | 0% |
| PVOH 35% | 20 | 7 | 30.7% |
| Glycerin | 5 | 5 | 22% |
| Neodol ® | 10 | 10 | 44% |
| Silica | 0.75 | 0.75 | 3.3% |

TABLE 23
SG-5797-3-04

| Component | Wet Weight (g) | Dry Weight (g) | Wt. % |
|---|---|---|---|
| Water | 15 | 0 | 0% |
| PVOH 35% | 20 | 7 | 30.4% |
| Glycerin | 5 | 5 | 21.7% |
| Neodol ® | 10 | 10 | 43.5% |
| Silica | 1 | 1 | 4.4% |

TABLE 24

| Sample | Grease Absorbed (g) |
|---|---|
| SG-5797-3-01 | 0.3 |
| SG-5797-3-02 | 0.34 |
| SG-5797-3-03 | 0.23 |
| SG-5797-3-04 | 0.2 |

The data of TABLE 24 in view of the compositions of TABLES 20-23 is indicative that an increase in silica concentration increases the capability of PVOH to bind nonionic surfactant concentrations.

### Example 9

A series of samples using varying soluble polymers with constant concentrations of detergent compositions were formulated as flowable foam mixtures, placed between filter papers, and dried to assess the binding capability of each water soluble polymer. Six sample formulations are shown below in TABLES 25-30. The mass of the filter papers was measured before and after heating to calculate the grease retention of each sample. The grease retention data is shown below in TABLE 31.

TABLE 25
SG-5797-35A

| Component | Wet Weight (g) | Dry Weight (g) | Wt. % |
|---|---|---|---|
| Water | 60 | 0 | 0.0% |
| HPMC (Methocel F50) | 7 | 7 | 10.9% |
| Polyethylene Glycol | 20 | 20 | 31.3% |
| Acylic acid homopolymer | 1 | 1 | 1.6% |
| (Accusol 445N) | | | |
| Dodecyl benzene sulfonic | 11 | 11 | 17.2% |
| acid (Biosoft S-118) | | | |
| Alcohol Ethoxylate | 12 | 12 | 18.8% |
| (Neodol 25-7) | | | |
| MEA | 4 | 4 | 6.3% |
| Triethyl Citrate | 1 | 1 | 1.6% |
| Cornstarch | 8 | 8 | 12.5% |

TABLE 26
SG-5797-35B

| Component | Wet Weight (g) | Dry Weight (g) | Wt. % |
|---|---|---|---|
| Water | 60 | 0 | 0.0% |
| PVOH | 7 | 7 | 10.9% |
| Polyethylene Glycol | 20 | 20 | 31.3% |
| Acylic acid homopolymer | 1 | 1 | 1.6% |
| (Accusol 445N) | | | |
| Dodecyl benzene sulfonic | 11 | 11 | 17.2% |
| acid (Biosoft S-118) | | | |
| Alcohol Ethoxylate | 12 | 12 | 18.8% |
| (Neodol 25-7) | | | |
| MEA | 4 | 4 | 6.3% |
| Triethyl Citrate | 1 | 1 | 1.6% |
| Cornstarch | 8 | 8 | 12.5% |

TABLE 27
SG-5797-35C

| Component | Wet Weight (g) | Dry Weight (g) | Wt. % |
|---|---|---|---|
| Water | 60 | 0 | 0.0% |
| Xanthan gum | 7 | 7 | 10.9% |
| Polyethylene Glycol | 20 | 20 | 31.3% |
| Acylic acid homopolymer | 1 | 1 | 1.6% |
| (Accusol 445N) | | | |
| Dodecyl benzene sulfonic | 11 | 11 | 17.2% |
| acid (Biosoft S-118) | | | |
| Alcohol Ethoxylate | 12 | 12 | 18.8% |
| (Neodol 25-7) | | | |
| MEA | 4 | 4 | 6.3% |
| Triethyl Citrate | 1 | 1 | 1.6% |
| Cornstarch | 8 | 8 | 12.5% |

TABLE 28
SG-5797-35D

| Component | Wet Weight (g) | Dry Weight (g) | Wt. % |
|---|---|---|---|
| Water | 60 | 0 | 0.0% |
| MCLV | 7 | 7 | 10.9% |
| Polyethylene Glycol | 20 | 20 | 31.3% |
| Acylic acid homopolymer | 1 | 1 | 1.6% |
| (Accusol 445N) | | | |
| Dodecyl benzene sulfonic | 11 | 11 | 17.2% |
| acid (Biosoft S-118) | | | |
| Alcohol Ethoxylate | 12 | 12 | 18.8% |
| (Neodol 25-7) | | | |
| MEA | 4 | 4 | 6.3% |
| Triethyl Citrate | 1 | 1 | 1.6% |
| Cornstarch | 8 | 8 | 12.5% |

TABLE 29
SG-5797-36A

| Component | Wet Weight (g) | Dry Weight (g) | Wt. % |
|---|---|---|---|
| Water | 60 | 0 | 0.0% |
| Hydroxyethylcellulose | 7 | 7 | 10.9% |
| (Natrosol) | | | |
| Polyethylene Glycol | 20 | 20 | 31.3% |
| Acylic acid homopolymer | 1 | 1 | 1.6% |
| (Accusol 445N) | | | |
| Dodecyl benzene sulfonic | 11 | 11 | 17.2% |
| acid (Biosoft S-118) | | | |
| Alcohol Ethoxylate | 12 | 12 | 18.8% |
| (Neodol 25-7) | | | |
| MEA | 4 | 4 | 6.3% |
| Triethyl Citrate | 1 | 1 | 1.6% |
| Cornstarch | 8 | 8 | 12.5% |

TABLE 30
SG-5797-36B

| Component | Wet Weight (g) | Dry Weight (g) | Wt. % |
|---|---|---|---|
| Water | 60 | 0 | 0.0% |
| Cellulose Gum (Sodium | 7 | 7 | 10.9% |
| Carboxymethylcellulose) | | | |
| Polyethylene Glycol | 20 | 20 | 31.3% |
| Acylic acid homopolymer | 1 | 1 | 1.6% |
| (Accusol 445N) | | | |
| Dodecyl benzene sulfonic | 11 | 11 | 17.2% |
| acid (Biosoft S-118) | | | |
| Alcohol Ethoxylate | 12 | 12 | 18.8% |
| Neodol 25-7) | | | |
| MEA | 4 | 4 | 6.3% |
| Triethyl Citrate | 1 | 1 | 1.6% |
| Cornstarch | 8 | 8 | 12.5% |

TABLE 31

| Sample | Average Grease Absorbed (g) |
|---|---|
| SG-5797-35A | 1.155 |
| SG-5797-35B | 2.895 |
| SG-5797-35C | 1.35 |
| SG-5797-35D | 1.02 |
| SG-5797-36A | 2.78 |
| SG-5797-36B | 2.715 |

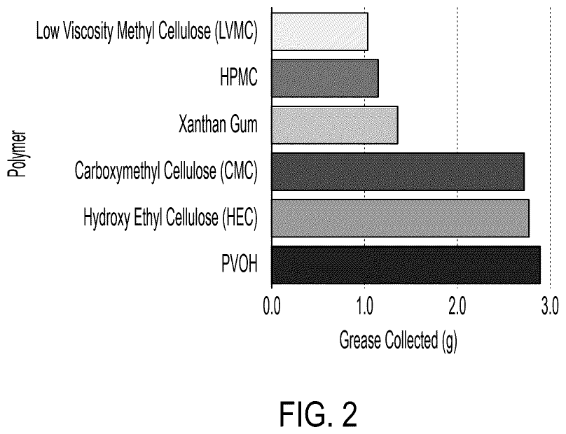

The data of TABLE 31 in view of the compositions of TABLES 25-30 is indicative that cellulose based polymers such as methyl cellulose low viscosity (MCLV/LVMC), HPMC, and Xanthan gum are more capable of binding nonionic surfactants in a detergent composition relative to the remaining samples. This correlation is further illustrated in FIG. 2.

The six samples were then tested for cleaning efficacy in a wash study. Flags containing a range of test stains and soils were washed in top-load washers (capacity=70 L), under conditions of 120 ppm (as CaCO₃) water hardness and temperature at 86° F. Percent stain removal (% SR) values were assessed using an imaging technique and measuring L*, a*, and b* parameters in the in the CIE L*a*b* color space. Values of AE, a root mean square color difference between the swatch and a non-soiled standard swatch, were calculated for unwashed and washed swatches using the equations of Formula (5) and Formula (6).

$$Before washing \text{:} Δ {E}_{u} = {[ {( {L}_{u} - {L}_{o} )}^{2} + {( {a}_{u} - {a}_{o} )}^{2} + {( {b}_{u} - {b}_{o} )}^{2} ]}^{1 / 2} \qquad ( 5 )$$

$$After washing \text{:} Δ {E}_{w} = {[ {( {L}_{w} - {L}_{o} )}^{2} + {( {a}_{w} - {a}_{o} )}^{2} + {( {b}_{w} - {b}_{o} )}^{2} ]}^{1 / 2} \qquad ( 6 )$$

In Formulas (5) and (6), u, w, and o correspond to values for unwashed swatch, washed swatches, and non-stained swatches, respectively. The % stain removal (% SR) was then calculated using the equation of Formula (7).

$$\% SR = [ ( Δ {E}_{u} - Δ {E}_{w} ) / Δ {E}_{u} ] \times 100 \qquad ( 7 )$$

Wash results are provided below in TABLE 32, which provides cleaning efficacy in terms of sum total percentage of stain/soil removal (% SR). The various samples were tested on fabrics made of woven cotton or polyester/cotton 65/35 soiled with a variety of agents, including blood, olive oil, chocolate ice cream, dirty motor oil, blueberry, gravy, dust, sebum, grape juice, mustard, wine, spaghetti sauce, tea, coffee, coffee with milk, grass, makeup, clay, chocolate syrup, beef tallow, meat drippings, burnt butter, and blue ball point ink.

TABLE 32

| Sample | Total Stain Removal % |
|---|---|
| SG-5797-35A | 2227 |
| SG-5797-35B | 2149 |
| SG-5797-35C | 2214 |
| SG-5797-35D | 2220 |
| SG-5797-36A | 2077 |
| SG-5797-36B | 2156 |

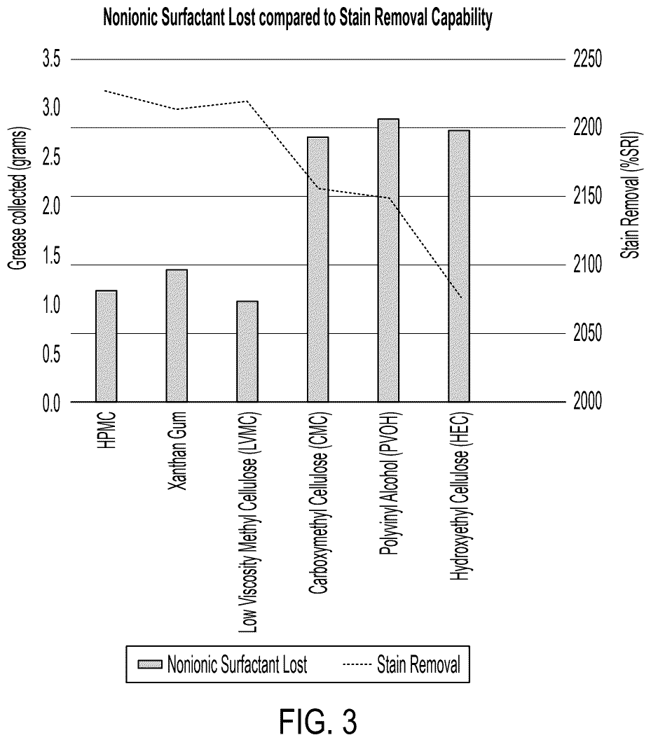

The data of TABLE 32 in view of the data of TABLE 31 is indicative that cellulose based polymers such as methyl cellulose low viscosity (MCLV/LVMC), HPMC, and Xanthan gum are more capable of removing stains from soiled fabrics relative to the remaining samples. This data as a function of the data of TABLE 31 is further illustrated in FIG. 3.

### Example 10

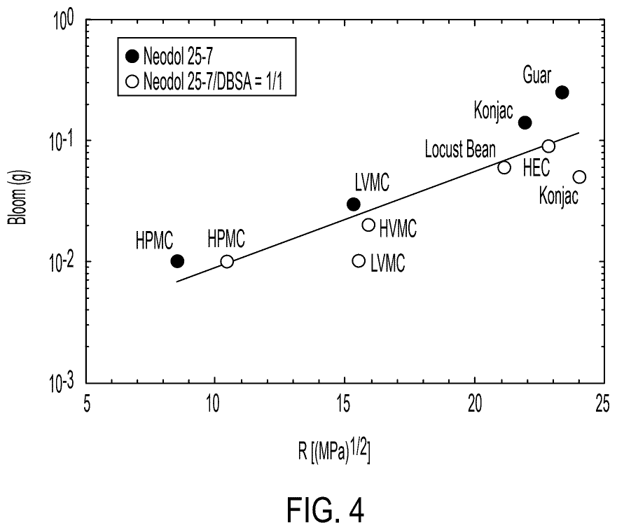

A series of samples using varying water soluble polymers with varying surfactants were formulated as flowable foam mixtures, placed between filter papers, and dried to assess the binding capability of each water soluble polymer. The mass of the filter papers were measured before and after heating to calculate the grease (nonionic surfactant) retention of each sample. For each sample, the HSP distance of the water soluble polymer and surfactant(s) was then calculated, the results of which are illustrated in FIG. 4 (“R”) as a function of grease retention (“Bloom”). The data illustrated in FIG. 4 indicates that water soluble polymer/solvent formulations having an HSP distance of about 20 or less produce less grease, and are thus more capable of binding nonionic surfactants relative to the remaining water soluble polymers having an HSP distance of greater than 20.

The terms “about”, “substantially”, and “generally” as used herein can indicate that certain recited values or conditions are intended to be read as encompassing the expressly recited value or condition and also values that are relatively close thereto or conditions that are recognized as being relatively close thereto. For example, unless otherwise indicated herein, a value of “about” a certain number or “substantially” or “generally” a certain value or result can indicate the specific number, value, or result as well as numbers, values, or results that vary therefrom (+ or −) 2% or less, or 1% or less. Similarly, unless otherwise indicated herein, a condition that substantially exists can indicate the condition is met exactly as described or claimed or is within typical manufacturing tolerances or would appear to meet the required condition upon casual observation even if not perfectly meeting the required condition. In some embodiments, the values or conditions may be defined as being express and, as such, the term “about” or “substantially” (and thus the noted variances) may be excluded from the express value. Where a plurality of possible lower end values and a plurality of possible upper end values are provided for a particular parameter, it is understood that all possible combinations of values inclusive of any of the lower end values and any of the upper end values are encompassed for describing the parameter.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A cleaning article comprising:
a detergent composition comprising at least one surfactant;
a film former comprising a cellulose-based polymer; and
a foam stabilizer;
wherein the cleaning article is configured as a substantially solid foam structure that is soluble in an aqueous liquid and is substantially non-flowing at a temperature of about 80° C. or less when out of contact with the aqueous liquid.

2. The cleaning article of claim 1, wherein the cleaning article comprises about 20% to about 80% by weight surfactants.

3. The cleaning article of claim 1, wherein the at least one surfactant comprises non-ionic surfactants.

4. The cleaning article of claim 3, wherein the at least one surfactant further comprises anionic surfactants.

5. The cleaning article of claim 1, wherein the cleaning article comprises about 1% to about 3% by weight foam stabilizer.

6. The cleaning article of claim 1, wherein the foam stabilizer comprises one or more citrate esters.

7. The cleaning article of claim 6, wherein the foam stabilizer comprises triethyl citrate, triethyl o-acetyl citrate, tributyl citrate, or combinations thereof.

8. The cleaning article of claim 1, wherein the cellulose-based polymer is a polysaccharide.

9. The cleaning article of claim 1, wherein the cellulose-based polymer comprises hydroxypropyl methylcellulose (HPMC), methyl cellulose low-viscosity (MCLV), xanthan gum, pullulan, or combinations thereof.

10. The cleaning article of claim 8, wherein the cleaning article comprises about 5% to about 15% by weight polysaccharide.

11. The cleaning article of claim 1, wherein one or more of the following conditions is met:
the cleaning article excludes polyvinyl alcohols;
the cleaning article has a porosity of about 0.2 g/cm³ to about 0.4 g/cm³;
the cleaning article is soluble in the aqueous liquid at a temperature of about 10° C. to about 30° C. in a time of about 2 minutes to about 10 minutes.

12. The cleaning article of claim 1, wherein the cleaning article is further configured as a sheet having a thickness, and a length and a width that are each greater than the thickness.

13. A cleaning article comprising:
a detergent composition comprising at least one surfactant;
a film former comprising a water-soluble polymer; and
a foam stabilizer;
wherein the cleaning article is configured as a substantially solid foam structure that is soluble in an aqueous liquid and is substantially non-flowing at a temperature of about 80° C. or less when out of contact with the aqueous liquid.

14. The cleaning article of claim 13, wherein the cleaning article comprises about 40% to about 80% by weight surfactants.

15. The cleaning article of claim 13, wherein the at least one surfactant comprises non-ionic surfactants.

16. The cleaning article of claim 15, wherein the at least one surfactant further comprises anionic surfactants.

17. The cleaning article of claim 13, wherein the cleaning article comprises at least about 2% by weight foam stabilizer.

18. A cleaning article comprising:
a detergent composition comprising at least one surfactant;
a film former comprising a cellulose-based polymer; and
a foam stabilizer;
wherein the cleaning article is configured as a substantially solid foam structure; and
wherein the Hansen Solubility Parameter Distance (Ra) of the film former and the at least one surfactant is about 20 MPa^{1/2} or less.

19. The cleaning article of claim 18, wherein the substantially solid foam structure is soluble in an aqueous liquid and is substantially non-flowing at a temperature of about 80° C. or less when out of contact with the aqueous liquid.

20. The cleaning article of claim 18, wherein the cleaning article comprises about 20% to about 80% by weight surfactants.
